(19) United States
(12) Patent Application Publication
(10) Pub. No.: US 2021/0286385 A1
(43) Pub. Date: Sep. 16, 2021

(54) AUTOMATIC PRESSURE DETECTION DEVICE OF INFLATION MACHINE

(71) Applicant: ANHUI FUYANG FENGJINBA MACHINERY & ELECTRIC CO., LTD., FU YANG CITY (CN)

(72) Inventor: Chi-Wen Chen, New Taipei City (TW)

(21) Appl. No.: 16/816,269

(22) Filed: Mar. 12, 2020

(51) Int. Cl. G05D 16/20

(52) U.S. Cl. CPC G05D 16/2066

(57) ABSTRACT

An automatic pressure detection device of an inflation machine includes an inflation machine and an inflation control module. A first connector of a connection pipe connected to the inflation machine is connected in sequence to a first hose line and a nozzle in order to charge gas into an object-to-be-inflated (such as a tire) for inflation. A second connector of the connection pipe connected to the inflation machine is connected in sequence to a valve core passage element of the inflation control module, a regulation and control valve, and a pressure transducer, and the pressure transducer is electrically connected to a circuit board. The valve core passage element and the nozzle are arranged to have the same flow so that the inflation control module may simulate a flow of gas charged into an object-to-be-inflated.

### TECHNICAL FIELD OF THE INVENTION

The present invention relates generally to an automatic pressure detection device of an inflation machine, and more particularly to a system that uses an inflation control module to control activation and de-activation of the inflation machine, wherein by making the flow through a valve core passage element of the inflation control module and that through a nozzle core of a nozzle attached to the object-to-be-inflated (such as a tire) identical to each other, the inflation control module may simulate the flow of gas charged into the object-to-be-inflated; by using the regulation and control valve of the inflation control module, the flow of gas can be set and regulate (limit) to make the pressure at an end of the regulation and control valve and an internal pressure of the object-to-be-inflated close to each other; and as such, with the pressure value detected by the pressure transducer of the inflation control module reaching a preset inflation level of the object-to-be-inflated, the circuit board of the inflation control module controls the inflation machine to shut down the operation thereof so that the inflation machine may carry out an inflation or charging operation that exactly follows a desired pressure level of the object-to-be-inflated.

### DESCRIPTION OF THE PRIOR ART

An inflation machine is operable in such a way that an internal electric machine directly drives a crankshaft to cause rotation of the crankshaft to thereby drive a connecting rod to move a piston up and down reciprocally, causing variation of a volume of a cylinder to compress and discharge a compressible gas. In the entire stroke of compression, due the variation of the cylinder volume, the compressed gas, such as air, is forced to move through a one-way valve (such as a check valve), so that the compressible gas is conducted through a hose to be discharged through a nozzle and flowing into an object for inflating the object.

To avoid excessive inflation of the object by the inflation machine that might cause explosion or break of the object, the existing inflation machine is often provided with a pressure gauge and a pressure detection device to ensure the inflation machine to carry out inflation of an object-to-be-inflated (such as a tire) according to a preset pressure. During the process of inflation, when the pressure detection device detects a gas pressure supplied from the inflation machine reaches the preset pressure level, the inflation machine stops operation automatically to prevent over pressurization resulting from excessive charging of gas into the object.

However, the existing inflation machine that is capable of pressure detection is provided with a pressure detection device that is often mounted at a location adjacent to a gas outlet port of the inflation machine. Physically, the pressure value detected at the outlet port of the inflation machine must be greater than an internal pressure of an object-to-be-inflated (such as a tire) at the moment of starting and during the process of inflation operation. Consequently, when the pressure detection device detects the output pressure of the inflation machine reaches a desired pressure level, such a value of pressure detected by the pressure detection device is actually the pressure at the outlet port of the inflation machine, rather than the actual pressure that the object-to-be-inflated (such as a tire) possess. As such, there is surely a difference between the pressure that the object-to-be-inflated actually possesses and the pressure reading of the pressure gauge after the inflation operation of the object-to-be-inflated has been done. This would lead to a consequence of incorrect pressure reading of the pressure that is actually fed into the object-to-be-inflated. As a result, the object that is so inflated may be used or put into operation in a condition of being insufficiently inflated and this would cause undesired concerns of performance and safety of operation of the object.

Thus, an existing inflation machine that is capable of pressure detection is structured by mounting a pressure detection device at a location of the nozzle of the discharge hose in order to correctly read the pressure that the object-to-be-inflated actually possesses and to reduce the deviation of pressure between the actual pressure possessed by the object-to-be-inflated and the output pressure of the inflation machine. However, in case of a large flow of pressurized gas supplied from the inflation machine, a physical back pressure situation may occur at the nozzle and as such, the pressure reading obtained with the pressure detection device mounted at a location of the nozzle is still not the correct pressure that the object-to-be-inflated is actually fed. For example, in case that the pressure detection device at the nozzle detects a pressure reading that is instantaneously increased, a control circuit of the inflation machine may incorrectly determine that the pressure of the object-to-be-inflated has reached a desired level, so that the control circuit may instruct the inflation machine to shut down the inflation operation, leading to a consequence that the actual pressure of the object-to-be-inflated is in fact not at a desired level of pressure.

Thus, it is an objective of the present invention to provide a solution that enables inflation of an object-to-be-inflated to be carried in a precise and accurate manner.

### SUMMARY OF THE INVENTION

An automatic pressure detection device of an inflation machine according to the present invention comprises an inflation machine and an inflation control module. The inflation machine comprises at least one outlet port, the outlet port being connected with a connection pipe, the connection pipe comprising a first connector and a second connector, the first connector being connected to a first hose line, the first hose line having an opposite end connected to a nozzle, the nozzle being provided, in an interior thereof, with a nozzle core, the nozzle being connectable to an object-to-be-inflated (such as a tire). The inflation control module comprises a valve core passage element, a regulation and control valve, a pressure transducer, and a circuit board, the valve core passage element being connected to and in communication with the second connector, a flow of gas through the valve core passage element being identical to a flow of gas through the nozzle core of the nozzle, the regulation and control valve being connected to and in communication with the valve core passage element in order to set a flow of gas, the pressure transducer being connected to and in communication with the regulation and control valve in order to detect a pressure of gas supplied out of the regulation and control valve, the circuit board being electrically connected with the pressure transducer and an electrical motor of the inflation machine, the circuit board receiving a pressure data detected by the pressure transducer and controlling activation/de-activation of the electrical motor.

The features of the present invention reside in that a portion of gas supplied from the inflation machine flow in sequence through the first connector of the connection pipe, the first hose line, and the nozzle to charge into the object-to-be-inflated (such as a tire) for inflation and a portion of the gas supplied from the inflation machine flows in sequence through the second connector of the connection pipe, the valve core passage element, the regulation and control valve, and the pressure transducer, such that the circuit board receives and reads the pressure data detected by the pressure transducer and controls the activation/de-activation of the electrical motor. As such, by making the flow through the valve core passage element of the inflation control module and that through the nozzle core of the nozzle attached to the object-to-be-inflated (such as a tire) identical to each other, the inflation control module may simulate the flow of gas charged into the object-to-be-inflated; by using the regulation and control valve of the inflation control module2, the flow of gas can be set and regulate (limit) to make the pressure at an end of the regulation and control valve and an internal pressure of the object-to-be-inflated close to each other; when the pressure value detected by the pressure transducer of the inflation control module reaches a preset inflation level of the object-to-be-inflated, the circuit board of the inflation control module controls the inflation machine to shut down the operation thereof so that the inflation machine 1 may carry out an inflation or charging operation that exactly follows a desired pressure level of the object-to-be-inflated.

### BRIEF DESCRIPTION OF THE DRAWINGS

FIG. 1 is a block diagram showing a structure of an automatic pressure detection device of an inflation machine according to the present invention.

FIG. 2 is a perspective view showing an automatic pressure detection device of an inflation machine according to a first embodiment of the present invention.

FIG. 3 is a perspective view, partly sectioned, showing a portion of the automatic pressure detection device of the inflation machine according to the first embodiment of the present invention.

FIG. 4 is a perspective view showing an automatic pressure detection device of an inflation machine according to a second embodiment of the present invention.

### DETAILED DESCRIPTION OF THE PREFERRED EMBODIMENT

For better understanding of the other features and advantages of the present invention and to more clearly demonstrate the efficacy that can be achieved thereby, the features and advantages of the present invention will be described in detail with reference to the attached drawings. Embodiments are provided below for the purpose of illustrating aspects of the present invention and is by no means intended to limit the scope of the present invention.

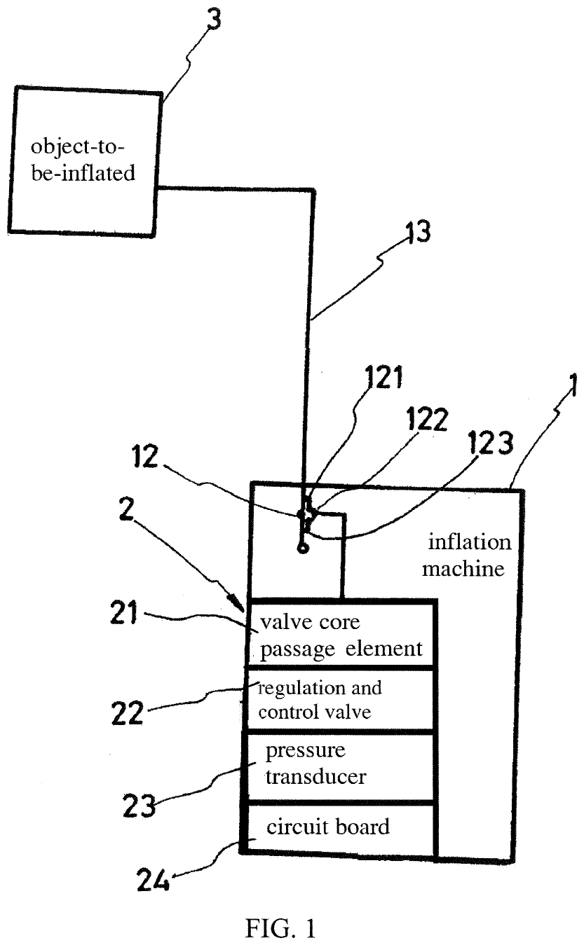

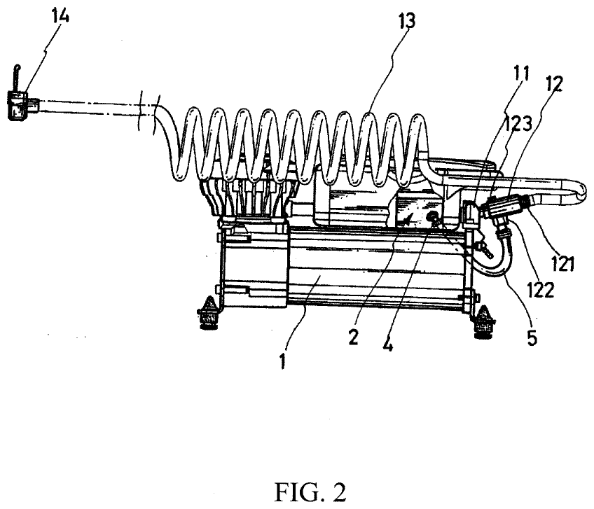

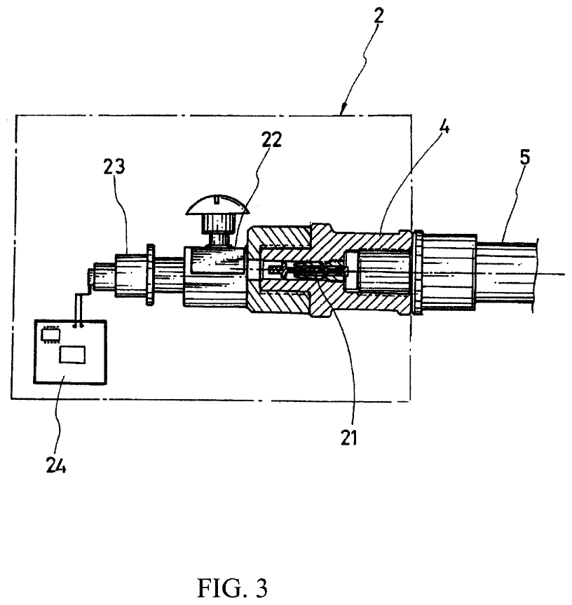

Referring to FIGS. 1-4, the present invention provides an automatic pressure detection device of an inflation machine that comprises an inflation machine 1 and an inflation control module 2.

The inflation machine 1 (such as an electrically-operated inflation machine) is provided with at least one outlet port 11. The outlet port 11 is connected with a connection pipe 12. The connection pipe 12 comprises a first connector 121 and a second connector 122. The first connector 121 is connected to and in communication with a first hose line 13. An opposite end (a distal end) of the first hose line 13 is connected to and in communication with a nozzle 14. The nozzle 14 is provided therein with a nozzle core, and the nozzle 14 is connectable with an object-to-be-inflated 3 (such as tire and a ball). Further, the connection pipe 12 may further comprise a third connector 123, and the third connector 123 is connected to a pressure display device (such as a mechanical pressure display or an electronic digital pressure display device, both being not shown). Since the pressure display device is not a novel part of the present invention, no further detail will be provided herein.

The inflation control module 2 comprises a valve core passage element 21, a regulation and control valve 22, a pressure transducer 23, and a circuit board 24 (such as a control circuit).

The valve core passage element 21 is connected to and in communication with the second connector 122 of the connection pipe 12. For example, the valve core passage element 21 may be fit, around an outside thereof, with a coupling joint 4, and an end of the coupling joint 4 is connected with a second hose line 5, and an opposite end of the second hose line 5 is connected with the second connector 122 so as to form communication among these elements, and, as such, the valve core passage element 21 and the second connector 122 are connected with each other to form communication with each other, so that gas supplied out through the second connector 122 is allowed to only pass through the valve core passage element 21 and a flow rate of the gas passing through the valve core passage element 21 is identical to a flow rate of the gas passing through the nozzle core of the nozzle 14.

The regulation and control valve 22 is connected to and in communication with the valve core passage element 21. For example, the regulation and control valve 22 is connected to an opposite end of the coupling joint 4, so that the regulation and control valve 22 and the valve core passage element 21 are connected with each other to form communication therebetween, and gas supplied out through the valve core passage element 21 is only allowed to pass through the regulation and control valve 22, and the regulation and control valve 22 is operable to set and regulate (limit) the flow rate of the outlet gas and thus the gas pressure that is output through the regulation and control valve 22 can be set and regulate.

The pressure transducer 23 is connected to and in communication with the regulation and control valve 22. For example, the pressure transducer 23 is connected to an opposite end (a distal end) of the regulation and control valve 22, so that the pressure transducer 23 may detect the level of pressure of the gas supplied out through the regulation and control valve 22.

The circuit board 24 is electrically connected to the pressure transducer 23 and an electrical motor arranged in the inflation machine 1. The circuit board 24 is operable to receive pressure data detected by the pressure transducer 23 and controls activation/de-activation of the electrical motor of the inflation machine 1. Further, the circuit board 24 is operable to set up an inflation pressure level that is charged into the object-to-be-inflated 3. Further, the circuit board 24 is electrically connected with an electrical power supply of the inflation machine 1, so that the circuit board 24 may be supplied with electrical power to provide to the inflation machine 1 for operation thereof.

An example will be provided for illustration of the present invention. When the inflation machine 1 is activated, a portion of gas supplied from the inflation machine 1 flows, in sequence, through the first connector 121 of the connection pipe 12, the first hose line 13, and the nozzle 14, in order to be charged into the object-to-be-inflated 3 (such as a tire) for inflation. Further, a portion of the gas supplied from the inflation machine 1 flows, in sequence, through the second connector 122 of the connection pipe 12, the second hose line 5, the valve core passage element 21, the regulation and control valve 22, and the pressure transducer 23, and the circuit board 24 receive and interpret the pressure data detected by the pressure transducer 23 and controls activation/de-activation of the electrical motor of the inflation machine 1.

Thus, the features of the present invention reside in that by making the flow through the valve core passage element 21 of the inflation control module 2 and that through the nozzle core of the nozzle 14 attached to the object-to-be-inflated 3 (such as a tire) identical to each other, the inflation control module 2 may simulate the flow of gas charged into the object-to-be-inflated 3; by using the regulation and control valve 22 of the inflation control module 2, the flow of gas can be set and regulate (limit) to make the pressure at an end of the regulation and control valve 22 and an internal pressure of the object-to-be-inflated 3 close to each other; when the pressure value detected by the pressure transducer 23 of the inflation control module 2 reaches a preset inflation level of the object-to-be-inflated 3, the circuit board 24 of the inflation control module 2 controls the inflation machine 1 to shut down the operation thereof so that the inflation machine 1 may carry out an inflation or charging operation that exactly follows a desired pressure level of the object-to-be-inflated 3.

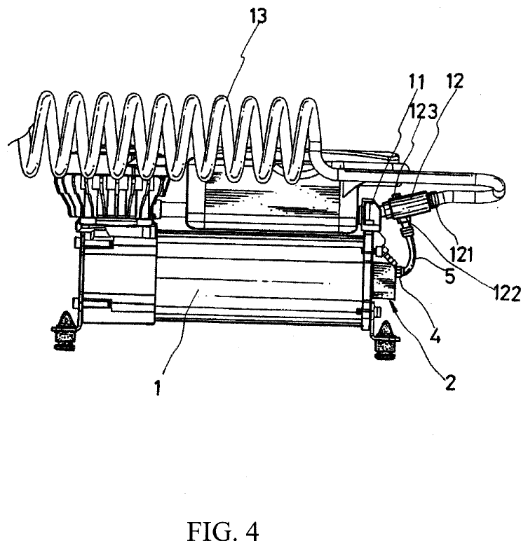

Further, the inflation control module 2 may be arranged in an interior of the inflation machine 1 to be integrally combined with the inflation machine 1 as a unitary structure (as shown in FIG. 1); or alternatively, the inflation control module 2 is arranged as an external structure that is attached to the inflation machine 1 through external coupling or connection (as shown in FIG. 4).

I claim:

1. An automatic pressure detection device of an inflation machine, comprising:
an inflation machine, which comprises at least one outlet port, the outlet port being connected with a connection pipe, the connection pipe comprising a first connector and a second connector, the first connector being connected to a first hose line, the first hose line having an opposite end connected to a nozzle, the nozzle being provided, in an interior thereof, with a nozzle core, the nozzle being connectable to an object-to-be-inflated; and
an inflation control module, which comprises a valve core passage element, a regulation and control valve, a pressure transducer, and a circuit board, the valve core passage element being connected to and in communication with the second connector, a flow of gas through the valve core passage element being identical to a flow of gas through the nozzle core of the nozzle, the regulation and control valve being connected to and in communication with the valve core passage element in order to set a flow of gas, the pressure transducer being connected to and in communication with the regulation and control valve in order to detect a pressure of gas supplied out of the regulation and control valve, the circuit board being electrically connected with the pressure transducer and an electrical motor of the inflation machine, the circuit board receiving a pressure data detected by the pressure transducer and controlling activation/de-activation of the electrical motor;
wherein a portion of gas supplied from the inflation machine flow in sequence through the first connector of the connection pipe, the first hose line, and the nozzle to charge into the object-to-be-inflated for inflation and a portion of the gas supplied from the inflation machine flows in sequence through the second connector of the connection pipe, the valve core passage element, the regulation and control valve, and the pressure transducer, such that the circuit board receives and reads the pressure data detected by the pressure transducer and controls the activation/de-activation of the electrical motor.

2. The automatic pressure detection device of the inflation machine according to claim 1, wherein the valve core passage element is fit, around an outside thereof, with a coupling joint, the coupling joint having an end connected to a second hose line, the second hose line having an end connected to the second connector to form communication therebetween, the valve core passage element and the second connector being connected to each other to form communication therebetween.

3. The automatic pressure detection device of the inflation machine according to claim 1, wherein the pressure transducer is connected to an end of the regulation and control valve to detect a pressure level of gas supplied through the regulation and control valve.

4. The automatic pressure detection device of the inflation machine according to claim 1, wherein the inflation control module is directly arranged in combination with the inflation machine to form a unitary structure.

5. The automatic pressure detection device of the inflation machine according to claim 1, wherein the inflation control module is attached to the inflation machine through external connection.
